(19) United States
(12) Patent Application Publication
(10) Pub. No.: US 2014/0308384 A1
(43) Pub. Date: Oct. 16, 2014

(54) MOLDING ROLLER AND METHOD FOR MANUFACTURING SAME

(71) Applicant: HON HAI PRECISION INDUSTRY CO., LTD., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 14/192,876

(22) Filed: Feb. 28, 2014

(30) Foreign Application Priority Data
Apr. 10, 2013 (TW) 102112601

(51) Int. Cl. B29C 33/56

(52) U.S. Cl. CPC B29C 33/56
USPC 425/363; 427/135

(57) ABSTRACT

A molding roller includes a cylindrical main body and a film. The main body includes a circumferential surface. A number of microstructures formed on the circumferential surface. The film is formed on the circumferential surface and the microstructures. The film is made of silicon carbide mixed with Diamond-like Carbon. The contact angle of water droplet of the film is larger than 120 degrees.

### BACKGROUND

1. Technical Field

The present disclosure relates to a molding roller and a method for manufacturing the molding roller.

2. Description of Related Art

Optical films, such as diffusion films, brightness enhancement films, or prism sheets are preferred for use in a backlight module for guiding light. An optical film usually includes a number of microstructures. The optical film with the microstructures can be manufactured through a pressing method using two molding rollers. Each of the molding rollers includes a main body and a copper film surrounding a circumferential surface of the main body and having microstructures. During manufacturing the optical film, hot melted resin is first introduced into a channel between the two molding rollers that are heated. Then, the hot melted resin is cooled, and the cooled resin is pressed by the two molding rollers to imprint microstructures on the pressed resin.

In the above process, if the molding roller's temperature is too high, the optical film is easily destroyed. If the molding roller's temperature is too low, the hot melted resin will have a low mobility, and the efficiency of imprinting microstructures will be low.

Therefore, it is desirable to provide a molding roller for manufacturing the optical film and a method for manufacturing the molding roller, which can overcome or alleviate the above-mention problems.

### BRIEF DESCRIPTION OF THE DRAWINGS

FIG. 1 is an isometric, schematic view of an exemplary embodiment of a molding roller.

FIG. 2 is a cross-sectional view of the molding roller, taken along the line II-II of FIG. 1.

FIG. 3 is a schematic view, showing the molding roller being manufactured.

### DETAILED DESCRIPTION

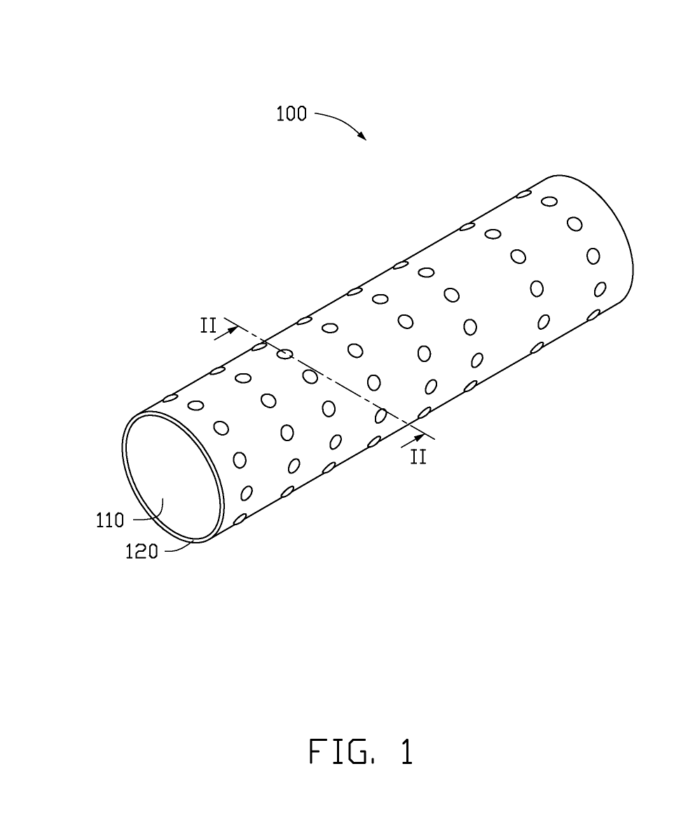

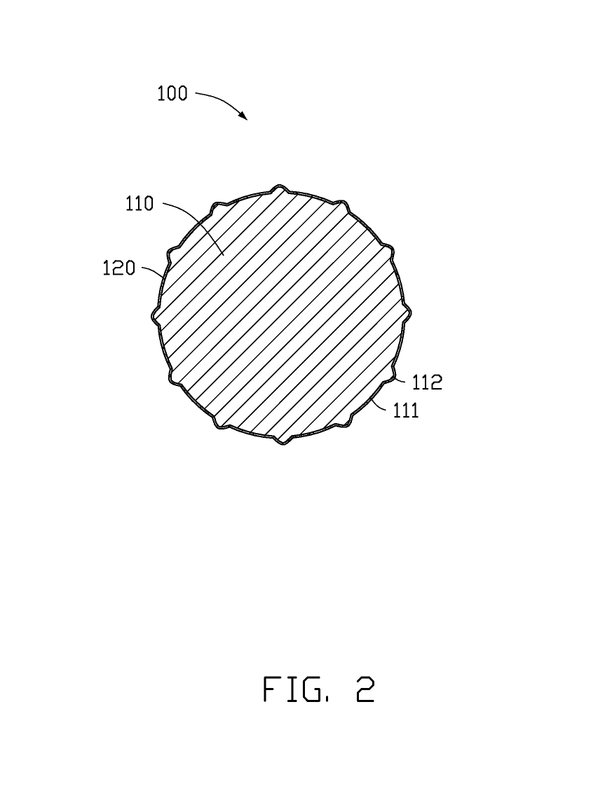

FIGS. 1 and 2 show an exemplary embodiment of a molding roller 100. The molding roller 100 includes a main body 110 and a film 120.

The main body 110 is substantially cylindrical and includes a circumferential surface 111. A number of microstructures 112 are formed on the circumferential surface 111. In this embodiment, the main body 110 is made of copper.

FIG. 2 shows that the film 120 is substantially seamless ring-shaped, and is directly coated on the circumferential surface 111 and the microstructures 112. The film 120 is made of silicon carbide (SiC) which is mixed with Diamond-like Carbon. The thickness of the film 120 is in range from 150 nanometers to 250 nanometers. The surface roughness of the film 120 is less than 10 nanometers. The contact angle of water droplet of the film 120 is larger than 120 degrees. In this embodiment, the thickness of the film 120 is about 200 nanometers. The surface roughness of the film 120 is optimized to be in a range from 5 nanometers to 8 nanometers. The contact angle of water droplet is optimized to be in a range from 120 degrees to 150 degrees.

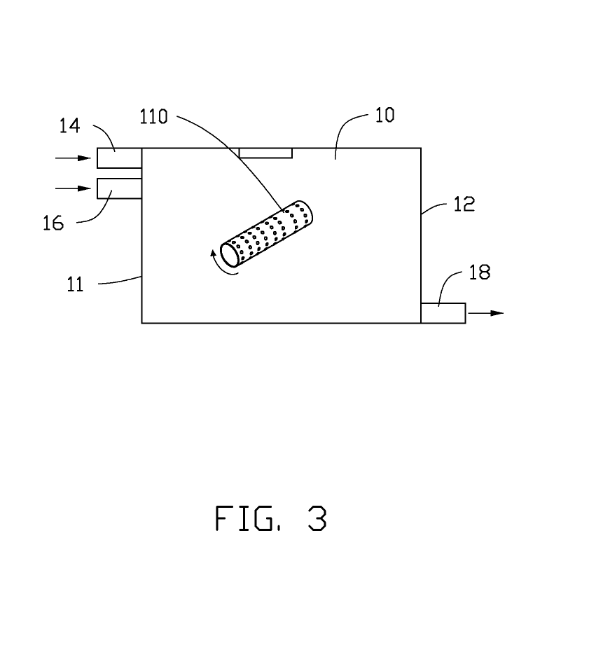

FIG. 3 shows that the molding roller 100 is manufactured. A method for manufacturing the molding roller 100 includes the following steps.

In step I, a main body 110 and a chamber 10 are provided. In detail, the main body 110 is substantially cylindrical and includes a circumferential surface 111. A number of microstructures 112 are formed on the circumferential surface 111 by a carving method. The main body 110 is made of copper. The chamber 10 is substantially a hollow cuboid and includes a first sidewall 11 and a second sidewall 12. The first sidewall 11 and the second sidewall 12 are positioned at opposite sides of the chamber 10, and the first sidewall 11 is substantially parallel to the second sidewall 12. The first sidewall 11 defines a first inlet 14 and a second inlet 16. The first inlet 14 is spaced apart from the second inlet 16. A vacuum pump 18 is mounted in the second sidewall 12 to evacuate the chamber 10.

In step II, a film 120 is formed on the circumferential surface 111 and the microstructures 112 using a plasma enhanced chemical vapor deposition (PECVE) method. In detail, first, the main body 110 is placed in the chamber 10. Second, the vacuum pump 18 evacuates the chamber 10 to make the vacuum degrees of the chamber 10 to be about 0.1 ton. Third, reaction gas, such as acetylene or methane, is introduced into the chamber 10 through the first inlet 14. Fourth, precursor gas, such as silane or Hexamthyldisiloxane (HMDSO) is introduced into the chamber 10 through the second inlet 16. Fifth, a radio-frequency voltage is applied to the reaction gas and the precursor gas, and the main body 110 is rotated in the chamber 10. Therefore, the film 120 is formed on the circumferential surface 111 and the microstructures 112. In this embodiment, the thickness of the film 120 can be controlled by the time of PECVE.

In the molding roller 100, the film 120 has a low friction coefficient and a high hardness because of the film 120 is made of SiC which is mixed with Diamond-like Carbon. This can increase mobility of resin, which is used for forming optical films so that the efficiency of imprinting microstructures is increased. Furthermore, the film 120 has a good thermal stability because of the SP3 bond between carbon atom and silicon atom. Therefore, the film 120 can withstand a high temperature condition.

Even though numerous characteristics and advantages of the present embodiments have been set fourth in the foregoing description, together with details of the structures and functions of the embodiments, the disclosure is illustrative only, and changes may be made in details, especially in the matters of shape, size, and arrangement of parts within the principles of the disclosure to the full extent indicated by the broad general meaning of the terms in which the appended claims are expressed.

What is claimed is:

1. A molding roller comprising:
a cylindrical main body comprising a circumferential surface and a plurality of microstructures on the circumferential surface; and
a film formed on the circumferential surface and the microstructures, the film made of silicon carbide mixed with Diamond-like Carbon, and the contact angle of water droplet of the film being larger than 120 degrees.

2. The molding roller of claim 1, wherein the surface roughness of the film is less than 10 nanometers.

3. The molding roller of claim 1, wherein the thickness of the film is in range from 150 nanometers to 250 nanometers.

4. The molding roller of claim 1, wherein the main body is made of copper.

5. A method for manufacturing a molding roller comprising:
providing a cylindrical main body and a chamber, the main body comprising a circumferential surface with a plurality of microstructures formed on the circumferential surface;
forming a film on the circumferential surface and the microstructures using a plasma enhanced chemical vapor deposition method, the film made of silicon carbide mixed with Diamond-like Carbon, and the contact angle of water droplet of the film being larger than 120 degrees.
